(19) United States
(12) Patent Application Publication
(10) Pub. No.: US 2005/0232736 A1
(43) Pub. Date: Oct. 20, 2005

(54) METHOD AND SYSTEM FOR CONSTRUCTION DEBRIS REMOVAL FROM A CONSTRUCTION SITE

(76) Inventors: Mark Fellows, Deland, FL (US); Peter J. Arculeo, Casselberry, FL (US)

Correspondence Address: MALIN HALEY AND DIMAGGIO, PA, 1936 S ANDREWS AVENUE, FORT LAUDERDALE, FL, 33316, US

(21) Appl. No.: 10/709,139

(22) Filed: Apr. 15, 2004

(51) Int. Cl. B62B 1/00

(52) U.S. Cl. 414/487

(57) ABSTRACT

A method and system for removing construction debris to greatly reduce cost and improve the aesthetics and removal of hazardous debris from a construction site. The system includes using a predetermined-sized small steel bin placed at the site that is small enough to be cost effective while at the same time having sufficient storage space for construction debris. A low cost vehicle is used that includes a capture arm that is controlled by a single person for removing trash from the steel bin that is placed in the low cost truck and removed on a periodic basis.

### BACKGROUND OF INVENTION

1. Field of the Invention

This invention relates to a trash removal system especially useful for construction sites and the removal of construction debris to improve the overall aesthetic environment around the construction site during construction and reduce the cost to builders for debris removal.

2. Description of Related Art

At home or business construction sites for either new construction or remodeling, building refurbishment or modernization, one of the problems faced by the builder or construction company is the removal of immense amounts of construction debris. Especially residential sites and small commercial building environments, adjacent landowners, building owners and home owners object to piles of debris lying around the construction site which can be dangerous and hazardous to the local residents. This is in addition to being very unsightly, often for weeks and months at a time. One of the conventional ways of dealing with construction debris is using a large dumpster at the site that employs very expensive machinery such as specially constructed trucks that visit the site periodically and physically lift the entire dumpster off the ground and empty it into the back of the large special truck. The main drawback to this type of dumpster system (an example of which is shown in U.S. Pat. No. 3,207,345 issued to Ord Sep. 21, 1965) is the tremendous expense. Many small construction companies, home construction people or small business construction entities cannot afford to either invest in the equipment necessary to provide a rollable dumpster or to afford the service to be provided because of the huge expense. U.S. Pat. No. 3,786,949 issued Jan. 22, 1974 shows a side loading truck and dumpster. Another system for a trash collecting and handling vehicle is shown in U.S. Pat. No. 4,128,182 issued Dec. 5, 1978 to Pickrell. This is an all inclusive truck that includes a grasping arm to lift the refuse container, a bed and the truck mechanism. Again, the drawback of a method and system like this is the large expense required for building specialized containers and the equipment for picking up the containers and dumping them into the truck bed. A smaller refuge loader device is shown in U.S. Pat. No. 5,391,037 issued Feb. 21, 1995 to Holton. This employs an extendable arm that can hoist a small trash container to allow it to be emptied into a large truck bed.

None of the above methods or systems previously used for construction debris containment and disposal services is economically feasible, especially for a small builder or small construction company because each system requires specialized receptacles and lifting systems. The purpose of the present invention is to provide aesthetically attractive, steel trash bins sized for economically and conveniently maintaining construction debris in a high enough bin that debris is not observable to the public. The trash bins of the present invention take up less than half the usual volume and space of traditional large expensive dumpsters. The present system employs the use of a low cost trash removal truck that includes a short engagement arm. The smaller truck can visit the site periodically, even more than once a week, and with one operator physically lift out the trash from the steel trash bin and put the debris directly in the truck bed. Each bin is sized and aesthetically designed to be placed anywhere near the construction area, even near a home or driveway. The unsightly debris and trash are now contained, are hidden from view, and are no longer a hazard to the public. The entire removal system and method are designed to be readily accessible to small builders, do it yourself builders and small contractors at greatly reduced expense.

### SUMMARY OF INVENTION

A method and system for containment and disposal of construction debris for use on site in a construction environment comprising a strategically sized and designed steel trash bin, substantially rectangular in shape with an open top and sized reasonably such as 8 feet by 6 feet and approximately 6 feet high to receive all sorts of construction debris. The small trash bin is conveniently transported to and placed on the job site by a truck. The bin can be located near a home, yard or in a residential neighborhood because the trash bin does not detract from the aesthetic environment around the construction site. The system and method includes providing a relatively low cost truck having a debris capture and removal arm. The truck visits the trash bin periodically (either weekly or two or three times a week) and by manual control of a single operator physically lifts out the trash from the trash bin and lifts the trash directly into the truck bed. Once the bin is emptied, the truck hauls the debris away. The vehicle used can be a four wheel truck with a hydraulically powered arm that includes a debris grasping device on the end of the arm that is sufficiently long enough to reach over and into the steel trash bin. By the use of a truck mounted operator controlled hydraulic arm, the grasping arm can be used to remove the trash directly from the trash bin and into the low cost truck. By using very low cost equipment and small sized steel bins, the costs are kept very low for the entire system. The method and system can be used quite effectively in any aesthetic environment including a residential neighborhood, strip malls, and office complexes. The system eliminates the view of large piles of debris and construction trash which could be very hazardous to people in the local environment. In addition, by using a light weight truck and grasping arm, the truck can have access to the dumpster without damaging the environment because of the lower weight of the truck.

Using the present method, a small construction company building or remodeling a home in a residential neighborhood would have the strategically-sized small trash bin positioned at a convenient location at to the home building site. The construction company contracts with the debris removal service provider to have a small truck visit the site two or three times a week, depending on the amount of debris generated per week and the type of construction conducted to physically remove the trash from the trash bin on a periodic basis. At all times the trash is not visible to anyone in the surrounding environment. The use of the light weight equipment for the truck and hauling arm greatly reduces the overall costs to the builder. The bins are strategically sized and take up less than half the space of a normal huge dumpster. A bin can be emptied weekly even if the bin is only partially full, because the system is so cost effective using this equipment.

The method of trash removal may include flat rate pricing per construction unit for complete service. The bin is small enough to be placed anywhere in the front or rear of a home including a driveway apron. This allows subcontractors to always have a trash container for daily clean up ensuring that the trash is out of view and does not pile up in the job site yard.

It is an object of this invention to provide an improved low cost containment and disposal service for construction debris.

It is another object of this invention to provide an improved method and system for construction debris containment and removal at greatly reduced costs and small equipment utilization.

Yet still another object of the invention is to provide a method and system for construction debris removal that employs aesthetically effective, low-priced trash bins of predetermined sizes that fit conveniently, especially at small job sites such as in residential neighborhoods for home construction or small business construction.

And yet still another object of this invention is to utilize trash removal equipment that is light weight and low cost to greatly reduce the cost of construction trash removal making construction more cost effective and efficient.

In accordance with these and other objects which will become apparent hereinafter, the instant invention will now be described with particular reference to the accompanying drawings.

### BRIEF DESCRIPTION OF DRAWINGS

FIG. 1 shows a perspective view of a solid steel trash bin used with the present invention.

FIG. 2 shows a light weight trash removal vehicle that can be used with the present invention.

FIG. 3 shows a schematic diagram of the method.

### DETAILED DESCRIPTION

Referring now to the drawings and in particular FIG. 1, a specifically designed steel trash bin 12 is shown having a predetermined height 12a of approximately 6 feet, a predetermined length 12b of approximately 8 feet and a predetermined width 12c of approximately 6 feet. The steel bin is designed to recover 8 foot plywood and other boards along with other construction debris through the open top while at the same time being aesthetically pleasing so that by the bin being 6 feet tall, debris is not observable by people at the site. The construction debris is placed continuously during the construction project into the bin which is conveniently located next to the construction project.

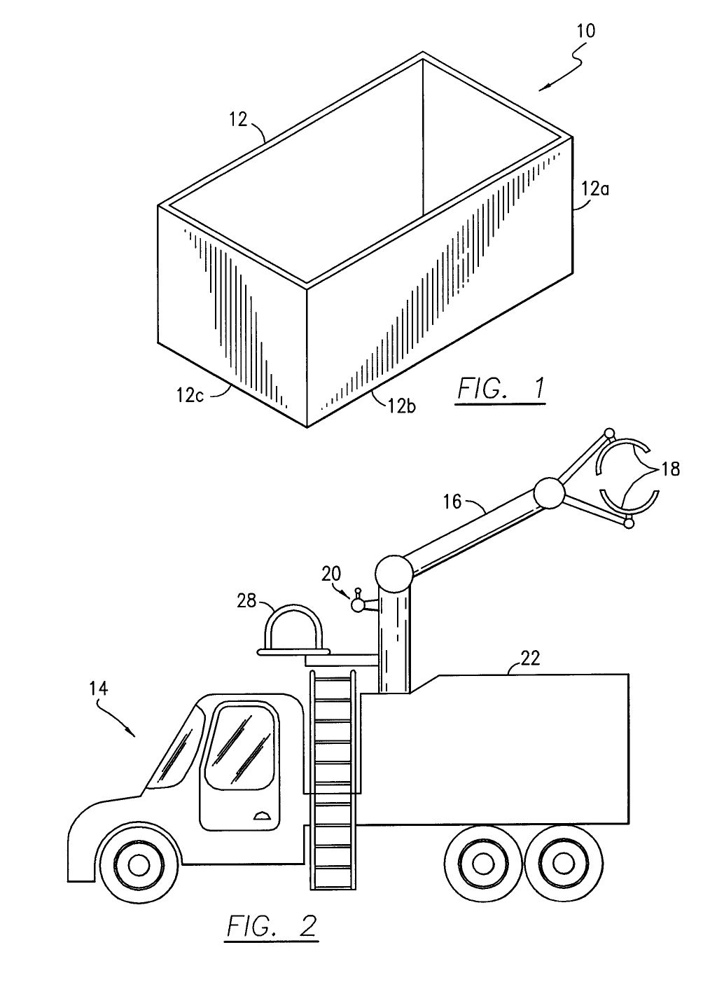

Referring now to FIG. 2, a vehicle 14 is shown that includes a hydraulic lift arm 16 and a pair of gripping arms that are mechanically controlled by a hydraulic control 20 that manipulates the position of the debris collectors 18 relative to the vehicle 14 and the truck bed 22. The trash removal vehicle 14 is relatively small in length and weight and is sized so that the mechanical arm 16 can be manipulated by a human operator seated on chair 28 using hydraulic control 20 to remove trash directly from the bin 12 shown in FIG. 1 conveniently and easily. The trash is then moved from bin 12 and placed into the space in the truck bed 22 in the back of truck 14. Truck 14 is a low cost vehicle compared to trucks used with specially lifted dumpsters that are mechanically lifted at the site. The size of the bin is small enough to be conveniently and aesthetically pleasing in the front of a small construction project such as in a residential neighborhood. In operation, the truck 14 would service multiple trash bin sites each having a bin 12 and remove the trash on a periodic basis but at very low cost relatively to other trash removal systems. Truck 14 is capable of operation by a single driver that can also manipulate arm 16 using control 20 to transfer debris from the bin 12 to the truck bed 22. The periodic schedule can also economically include days when the bin is only half full.

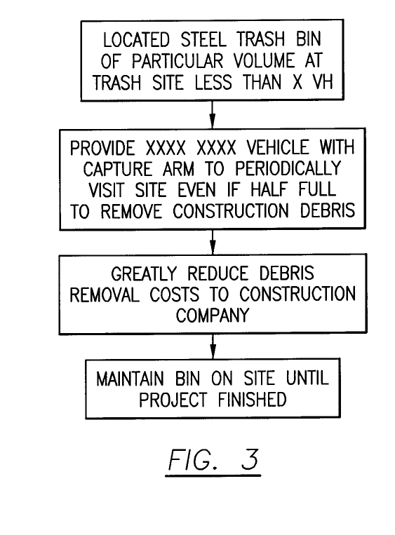

Referring now to FIG. 3, the flow chart shows the process of reducing costs for construction debris removal while at the same time providing an aesthetic environment in the construction area and removal hazardous debris from being present in the area. First of all, a pre-selected small steel bin of a particular size is selected and placed at the construction site. Preferably the bin is 8 feet by 6 feet by 6 feet. The bin is all steel and it is has a clean appearance from the outside. It is long enough to accommodate sheets of plywood that are 8 feet longer (standard size). A low cost truck or vehicle is provided that has a capture arm that requires one person operation and has a truck bed storage bin to retrieve the trash out of the steel trash bin placed into the truck bin. By using a very low cost truck with one person operation, the operating costs are greatly reduced. The trash removal time period may come on a periodic basis such as two or three times a week even when the bin is not full because of the low cost approach. The trash bin is easily delivered to the site and maintained at the site until the construction project is over. The entire service can be provided at a predetermined low cost so that the construction owner does not have to pay for any of the equipment. The equipment for the present invention is such that the equipment can be conveniently leased at low cost.

The instant invention has been shown and described herein in what is considered to be the most practical and preferred embodiment. It is recognized, however, that departures may be made therefrom within the scope of the invention and that obvious modifications will occur to a person skilled in the art.

1. A system for low cost construction debris removal and to provide aesthetic debris storage comprising:
a small steel rectangular trash bin less than 9 feet long, less than 6 feet wide, and less than 6 feet high for receiving construction debris; and
a small vehicle having a debris sized bed and grasping means to recover debris from said bin using a single operator.

2. A system as in claim 1, wherein:
said vehicle includes a debris removal arm sized to reach over and into said bin.

3. A method of economically removing trash from a construction site comprising the steps of:
(1) providing a small steel trash bin less than 8 feet long, less than 4 feet wide and less than 6 feet high at a construction site; and
(2) using a small truck with a trash storing bed at said site periodically to haul away trash.
